(19) United States
(12) Patent Application Publication
(10) Pub. No.: US 2022/0143763 A1
(43) Pub. Date: May 12, 2022

(54) METHOD OF MOUNTING CONNECTION ELEMENT STRUCTURE ON TARGET

(71) Applicant: TING-JUI WANG, New Taipei City (TW)

(72) Inventor: TING-JUI WANG, New Taipei City (TW)

(21) Appl. No.: 17/386,579

(22) Filed: Jul. 28, 2021

(30) Foreign Application Priority Data
Nov. 12, 2020 (TW) 109139467

(51) Int. Cl. B23K 37/04; H01R 12/57; H01R 12/58; H01R 43/02

(52) U.S. Cl. CPC B23K 37/0408; H01R 12/57; H01R 12/52; H01R 43/0256; H01R 12/58

(57) ABSTRACT

A method of mounting a connection element structure on a target is introduced and includes providing a lifting-laying tool to lift the connection element structure; moving the connection element structure to a default height above a mounting position of the target with the lifting-laying tool; and releasing or loosening the connection element structure from the lifting-laying tool to lay the connection element structure at the mounting position of the target. Therefore, the method can mount the connection element structure on the target, enhancing the efficiency of subsequent processes.

### CROSS-REFERENCE TO RELATED APPLICATION

This non-provisional application claims priority under 35 U.S.C. § 119(a) on Patent Application No(s). 109139467 filed in Taiwan, R.O.C. on Nov. 12, 2020, the entire contents of which are hereby incorporated by reference.

### BACKGROUND OF THE INVENTION

### 1. Field of the Invention

The present disclosure relates to a method of mounting a connection element structure on a target.

### 2. Description of the Related Art

A conventional connection element is typically for use in connecting two targets. Before the conventional connection element starts operating, a fixation medium (for example, solder or adhesive) is fixed to one of the targets. Then, the other target is fixed to a connection portion in the connection element, thereby allowing the two targets to be connected. However, when the conventional connection element is fixed to one of the targets first through the fixation medium (for example, solder or adhesive), contaminants (for example, dust or the fixation medium) often enters the connection portion in the connection element and thus often interferes with the connection portion of the connection element fixed to the other target, thereby reducing the efficiency of subsequent processes.

### BRIEF SUMMARY OF THE INVENTION

An objective of the present disclosure is to provide, in at least one embodiment of the present disclosure, a method of mounting a connection element structure on a target, such that the connection element structure is mounted on the target to enhance the efficiency of subsequent processes.

To achieve at least the above objective, the present disclosure provides a method of mounting a connection element structure on a target, the connection element structure comprising a body and a stop element, the method comprising the steps of: providing a lifting-laying tool to lift the connection element structure; moving the connection element structure to a default height above a mounting position of the target with the lifting-laying tool; and releasing or loosening the connection element structure from the lifting-laying tool to lay the connection element structure at the mounting position of the target.

To achieve at least the above objective, the present disclosure further provides a connection element structure and a method of mounting the connection element structure on the target, the connection element structure comprising a body and a stop element, the method comprising the steps of: providing a lifting-laying tool to lift the connection element structure; moving the connection element structure to a mounting position of the target with the lifting-laying tool; and pressing the connection element structure downward against the target with the lifting-laying tool and releasing or loosening the connection element structure from the lifting-laying tool to lay the connection element structure at the mounting position of the target.

To achieve at least the above objective, the present disclosure further provides a connection element structure and a method of mounting the connection element structure on the target, the connection element structure comprising a body and a stop element, the method comprising the steps of: providing a lifting-laying tool to lift the connection element structure; moving the connection element structure to a mounting position of the target with the lifting-laying tool; and pressing resiliently the connection element structure against the target with the lifting-laying tool and releasing or loosening the connection element structure from the lifting-laying tool to lay the connection element structure at the mounting position of the target.

To achieve at least the above objective, the present disclosure further provides a connection element structure and a method of mounting the connection element structure on the target, the connection element structure comprising a body and a stop element, the method comprising the steps of: providing a lifting-laying tool to lift the connection element structure; moving the connection element structure to a mounting position of the target with the lifting-laying tool; and sensing, by the lifting-laying tool, a feedback message indicative of contact between the connection element structure and the target and releasing or loosening the connection element structure from the lifting-laying tool to lay the connection element structure at the mounting position of the target.

The method of mounting a connection element structure on a target further comprises the steps of: comparing, by a comparison device, the connection element structure with the target to determine its mounting position or mounting distance after the lifting-laying tool has lifted the connection element structure; and moving the connection element structure to the mounting position of the target with the lifting-laying tool according to a comparison message of the comparison device.

The method of mounting a connection element structure on a target further comprises the steps of: comparing, by a comparison device, the connection element structure with the target to determine a position or distance of a weldable surface at the mounting position of the target after the lifting-laying tool has lifted the connection element structure; and moving the connection element structure to the weldable surface of the target with the lifting-laying tool according to a comparison message of the comparison device.

Preferably, the fixation portion is penetratingly fixed to the object, dentedly fixed to the object, raisedly fixed to the object or flatly fixed to the object.

Preferably, a body of the connection element structure has a connection portion and a fixation portion, the connection portion being disposed in the body, the body having at least one connection opening, the fixation portion being fixed to an object, wherein the stop element of the connection element structure is disposed at the connection opening.

Preferably, the connection portion is a via or a passage when the connection opening is in a plural number.

The method of mounting a connection element structure on a target is characterized in that the connection portion has a thread, clasp portion, raised portion or dented portion.

Preferably, the fixation portion is penetratingly fixed to the object, dentedly fixed to the object, raisedly fixed to the object or flatly fixed to the object.

Preferably, the stop element is a cork body, raised body, dented body, plate body, resilient body, board body, cylindrical body, helical body, viscous body, clasp body, film body, adhesive-like body, plastic body, metal body or integrally formed with the body.

Preferably, the stop element is squeezed into, riveted to, expandedly connected to, adhered to, welded to, fastened to, thermally fused with, painted onto, spraying-coated to, adhesive-dispensed to or integrally formed with the body.

Preferably, the connection opening is disposed at the fixation portion, and the transverse dimension of the stop element is equal to, greater than or less than the transverse dimension of the fixation portion.

Regarding the method of mounting a connection element structure on a target, the stop element is removed from the body under a force of 0.0005 kg to 200 kg.

Preferably, the stop element is disposed inside the connection opening, or outside the connection opening and partially inside the connection opening, or outside the connection opening.

Preferably, the stop element is stationary or removable.

Regarding the method of mounting a connection element structure on a target, the fixing element is disposed at the fixation portion or the object to fix the fixation portion to the object.

Preferably, the surface of the body, the stop element or the target has a welding plating layer for connecting to the fixing element or the target.

Preferably, the fixing element fixes the stop element to the body.

Preferably, the fixing element is tin paste, soldering flux, solder paste, glue, fixing agent, liquid, grease, solid, solder, viscous body, film body, adhesive-like body, plastic or metal.

Regarding the method of mounting a connection element structure on a target, a receiving body has at least one receiving chamber for receiving the body and the stop element.

Regarding the method of mounting a connection element structure on a target, a cover covers the receiving chamber.

Preferably, the receiving body is band-shaped or disk-shaped.

Preferably, the stop element prevents heated-and-molten solder from entering or flowing into the connection opening.

Regarding the method of mounting a connection element structure on a target, after the solder has been introduced and cooled to enable the body to be fixed to the target, the stop element is removed from the connection opening with a tool, so as to restore the fitting function of the connection portion.

Preferably, the connection portion is fitted to a corresponding fastening element, such that the body and the target are fitted together.

Preferably, the body has a rotation-proof portion, and the target has a corresponding rotation-proof portion. The rotation-proof portion and the corresponding rotation-proof portion prevent each other from rotating.

Preferably, a welding layer is disposed between the rotation-proof portion and the corresponding rotation-proof portion.

Preferably, the lifting-laying tool is a forceps-like tool, clasp-like tool, vacuum extraction device, magnetic suction device or resilient movable component.

Preferably, the comparison device is a visual comparison device, distance comparison device, image comparison device, AI comparison device or photographic comparison device.

Preferably, the stop element is mounted on the body to provide a hermetic seal thereto, allowing the tool to carry out vacuum extraction.

Preferably, a welding layer is disposed between the target and a lateral part of the fixation portion of the body or between the target and the fixation portion of the body.

Preferably, the body and the target each have a weldable surface, and the weldable surface is made of tin, copper or nickel.

To achieve at least the above objective, the present disclosure further provides a connection element structure and a method of mounting the connection element structure on the target, comprising the steps of:

(1) lifting-laying the connection element structure, such that the fixation portion of the connection element structure is disposed at the target, and the fixing element is disposed between the fixation portion of the connection element structure and the target;
(2) heating to soften or liquefy the fixing element; and
(3) cooling the fixing element such that the connection element structure is fixed to the target.

Preferably, in the step (1), the connection element structure performs the lifting-laying operation with a lifting-laying tool.

Preferably, the lifting-laying tool is a vacuum extractor or forceps-like tool.

Preferably, the vacuum extractor extracts the connection element structure, including the connection opening or not including the connection opening.

Preferably, in the step (2), the fixing element is heated up to be softened or liquefied, such that the fixing element flows into, sinks into, is drawn into, is squeezed into or is pressed into between the target and the fixation portion of the connection element structure.

Preferably, the fixing element fixes the stop element to the body.

Preferably, the fixing element is tin paste, soldering flux, solder paste, glue, fixing agent, liquid, grease, solid, solder, viscous body, film body, adhesive-like body, plastic or metal.

Preferably, the target is a circuit board, plastic target or metal target.

Preferably, the comparison device is a visual comparison device, distance comparison device, image comparison device, AI comparison device or photographic comparison device.

### BRIEF DESCRIPTION OF THE DRAWINGS

FIG. 1 is a schematic view of a connection element structure according to a preferred embodiment of the present disclosure.

FIG. 2 is a schematic view of a connection portion with a raised portion or dented portion according to a preferred embodiment of the present disclosure.

FIG. 3 is a schematic view of a fixation portion flatly mounted on an object according to a preferred embodiment of the present disclosure.

FIG. 4 is a schematic view of a fixation portion raisedly mounted on an object according to a preferred embodiment of the present disclosure.

FIG. 5 is a schematic view of a fixation portion dentedly mounted on an object according to a preferred embodiment of the present disclosure.

FIG. 6 is a schematic view of a fixation portion according to a preferred embodiment of the present disclosure.

FIG. 7 is a schematic view of a connection element structure, receiving body and cover according to a preferred embodiment of the present disclosure.

FIG. 8 is a schematic view 1 of a method of fixing the connection element structure in place according to a preferred embodiment of the present disclosure.

FIG. 9 is a schematic view 2 of a method of fixing the connection element structure in place according to a preferred embodiment of the present disclosure.

FIG. 10 is a schematic view of a lifting-laying tool according to a preferred embodiment of the present disclosure.

FIG. 11 is a schematic view 1 of the connection element structure mounted on the target according to a preferred embodiment of the present disclosure.

FIG. 12 is a schematic view 2 of the connection element structure mounted on the target according to a preferred embodiment of the present disclosure.

FIG. 13 is a schematic view 3 of the connection element structure mounted on the target according to a preferred embodiment of the present disclosure.

FIG. 14 is a schematic view 4 of the connection element structure mounted on the target according to a preferred embodiment of the present disclosure.

FIG. 15 is a schematic view 5 of the connection element structure mounted on the target according to a preferred embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

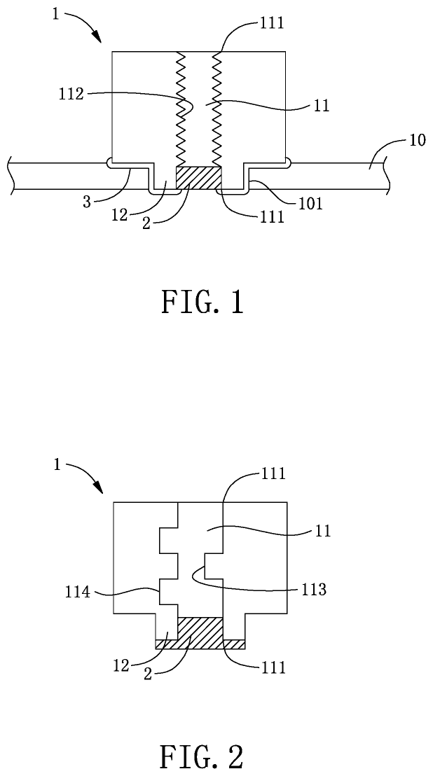

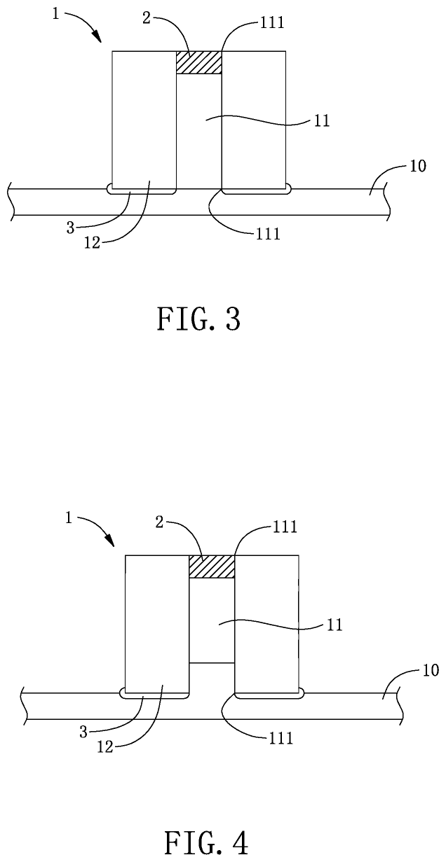

Referring to FIG. 1, the present disclosure provides a connection element structure, comprising a body 1 and a stop element 2. The body 1 is cylindrical, block-shaped or of any other shape. The body 1 has a connection portion 11 and a fixation portion 12. The connection portion 11 is disposed in the body 1. The body 1 has at least one connection opening 111. When the connection opening 111 is in a plural number, the connection openings 111 are or are not in communication with each other. The fixation portion 12 is disposed at any position outside the body 1 so as to be fixed to target 10; for example, the fixation portion 12 is disposed at one end or one side of the body 1 (shown in FIG. 1); alternatively, the fixation portion 12 is disposed on a lateral side of the body 1 (shown in FIG. 6), and the connection opening 111 is disposed inside the fixation portion 12 (or outside the fixation portion 12); the stop element 2 is disposed at the connection opening 111, such as the connection opening 111 below (shown in FIG. 1), or the connection opening 111 above (shown in FIG. 3), and the stop element 2 is disposed inside the connection opening 111 (shown in FIG. 1) so as to position the stationary stop element 2, or is disposed outside the connection opening 111 and partially inside the connection opening 111 (shown in FIG. 2) so as to position the removable stop element 2, or is disposed outside the connection opening 111 (shown in FIG. 8) so as to position the removable stop element 2. After the stationary stop element 2 and the body 1 have been fixed to the target 10, the stop element 2 stays with the body 1. After the removable stop element 2 and the body 1 have been fixed to the object 10, the stop element 2 can be removed from the body 1.

Therefore, the connection element structure of the present disclosure is advantageous in that, owing to the stop element 2, contaminants cannot enter connection portion 11 of the connection element structure to otherwise impede the connection of another target and the connection portion 11, so as to enhance the efficiency of subsequent processes.

Referring to FIG. 3, preferably, when the connection opening 111 is in a plural number, the connection portion 11 is a via or passage for connecting to another target. The via is a straight through hole. The passage meanders within the body.

Referring to FIG. 1 and FIG. 2, preferably, the connection portion 11 has a thread 112 (shown in FIG. 1), clasp portion, raised portion 113 or dented portion 114 (shown in FIG. 2) for connecting to another target.

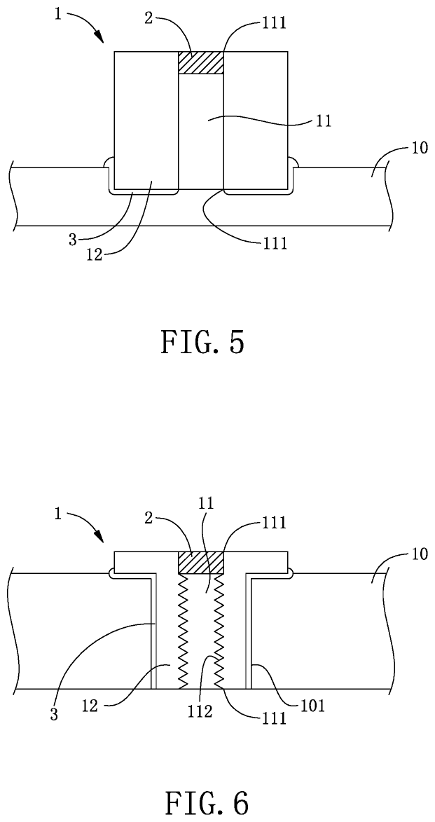

Referring to FIG. 1, FIG. 3, FIG. 4 and FIG. 5, preferably, the fixation portion 12 is penetratingly fixed to the object 10 (shown in FIG. 1), dentedly fixed to the object 10 (shown in FIG. 5), raisedly fixed to the object 10 (shown in FIG. 4) or flatly fixed to the object 10 (shown in FIG. 3).

Referring to FIG. 1, FIG. 2 and FIG. 8, preferably, the stop element 2 is a cork body (shown in FIG. 1), raised body (shown in FIG. 2), plate body (shown in FIG. 8) (or dented body, resilient body, board body, cylindrical body, helical body, viscous body, clasp body, film body, adhesive-like body, plastic body, metal body) or integrally formed with the body 1.

Preferably, the stop element 2 is squeezed into, riveted to, expandedly connected to, adhered to, welded to, fastened to, thermally fused with, painted onto, spraying-coated to, adhesive-dispensed to or integrally formed with the body 1.

Referring to FIG. 8, preferably, when the connection opening 111 is disposed at the fixation portion 12, the transverse dimension of the stop element 2 is equal to (or greater or less than) the transverse dimension of the fixation portion 12.

Referring to FIG. 1, the method of mounting a connection element structure on a target further requires a fixing element 3 disposed at the fixation portion 12 or the object 10 to fix the fixation portion 12 of the body 1 to a fixation hole 101 of the object 10. The surface of the body 1, the stop element 2 or the target 10 has a welding plating layer for connecting to the fixing element 3 or the target 10.

Referring to FIG. 1, preferably, the fixing element 3 temporarily or permanently fixes the stop element 2 to the body 1.

Preferably, the fixing element 3 is tin paste, soldering flux, solder paste, glue, fixing agent, liquid, grease, solid, solder, viscous body, film body, adhesive-like body, plastic or metal.

Regarding the method of mounting a connection element structure on a target, the stop element 2 is removed from the body 1 under a force of 0.0005 kg to 200 kg, so as to overcome the connection force between the stop element 2 and the body 1 or overcome the connection force between the stop element 2, the body 1 and the fixing element 3.

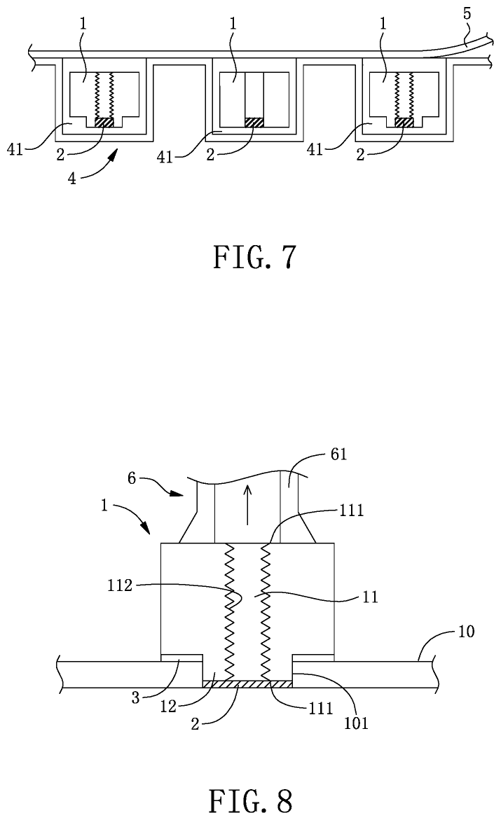

Referring to FIG. 7, the method of mounting a connection element structure on a target further requires a receiving body 4 which has at least one receiving chamber 41 for receiving the body 1 and the stop element 2.

Referring to FIG. 7, the method of mounting a connection element structure on a target requires a cover 5 for covering the receiving chamber 41 to prevent the escape of the body 1 and the stop element 2 from the receiving body 4.

Referring to FIG. 7, preferably, the receiving body 4 is band-shaped or is band-shaped and then extends horizontally to become disk-shaped.

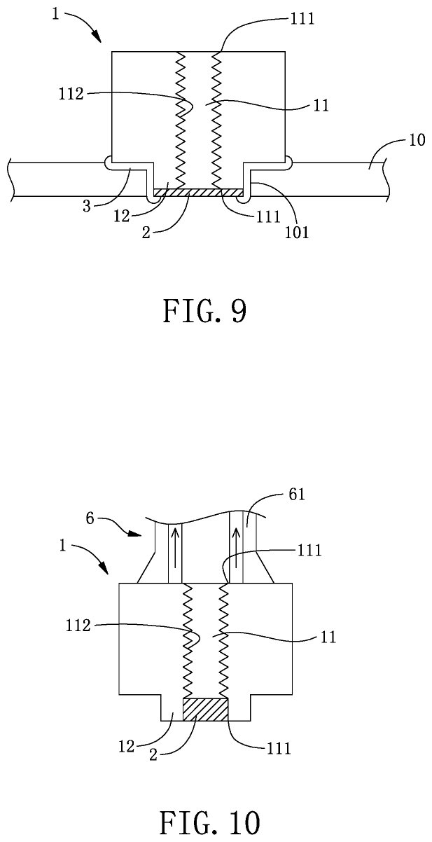

Referring to FIG. 8 and FIG. 9, the present disclosure provides a method of fixing a connection element structure in place, comprising the steps of:

(1) As shown in FIG. 8, lifting-laying the connection element structure, such that fixation portion 12 of the connection element structure is disposed at target 10, and fixing element 3 is disposed between fixation portion 12 of the connection element structure and the target 10, wherein the fixing element 3 is disposed at the vicinity of the fixation hole 101 of the object 10 or the fixation portion 12.

(2) As shown in FIG. 9, heating to soften or liquefy the fixing element 3 such that the fixing element 3 is connected between the fixation portion 12 and the target 10; and

(3) As shown in FIG. 9, cooling the fixing element 12 to solidify the fixing element 12, thereby allowing the connection element structure to be fixed to the target 10.

Referring to FIG. 8, preferably, in the step (1), the connection element structure is lifted and laid with the lifting-laying tool 6.

Referring to FIG. 8, preferably, the lifting-laying tool 6 is a vacuum extractor 61 (or forceps-like tool).

Referring to FIG. 8 and FIG. 10, preferably, the vacuum extractor 61 extracts the connection element structure, including the connection opening 111 (shown in FIG. 8) or not including the connection opening 111 (shown in FIG. 10).

Referring to FIG. 9, preferably, in the step (2), the fixing element 3 is heated up and thereby softened or liquefied, such that the fixing element 3 flows into, sinks into, is drawn into, is squeezed into or is pressed into between the target 10 and the fixation portion 12 of the connection element structure.

Referring to FIG. 9, preferably, the fixing element 3 temporarily or permanently fixes the stop element 2 to the body 1.

Preferably, the fixing element 3 is tin paste, soldering flux, solder paste, glue, fixing agent, liquid, grease, solid, solder, viscous body, film body, adhesive-like body, plastic or metal.

Preferably, the target 10 is a circuit board, plastic target or metal target.

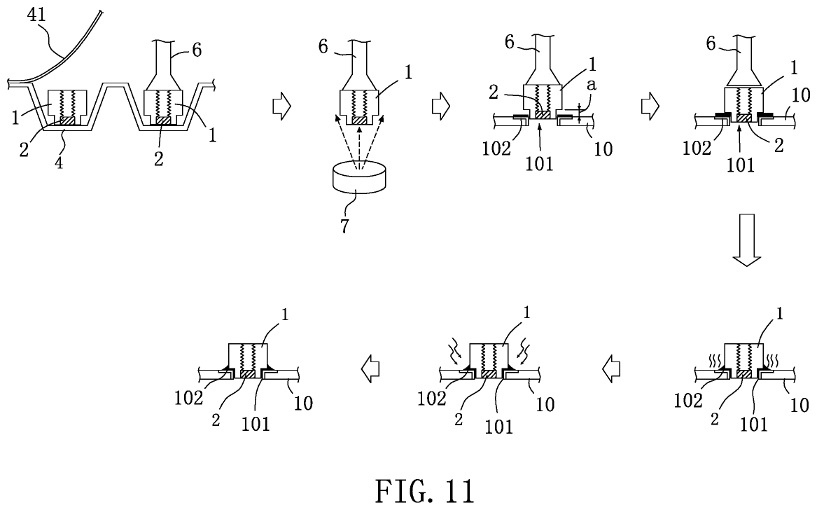

Referring to FIG. 11, the present disclosure provides a method of mounting a connection element structure on a target, wherein the connection element structure comprises a body 1 and a stop element 2. The method comprises the steps of:

providing a lifting-laying tool 6 to lift the connection element structure;

moving the connection element structure with the lifting-laying tool 6 to a predetermined height a above the mounting position (i.e., fixation hole 101) of the target 10;

releasing or loosening the connection element structure from the lifting-laying tool 6, such that the connection element structure falls and rests on the mounting position of the target 10. Therefore, not only is the connection element structure fixed to the target 10, so as to enhance the efficiency of subsequent processes, but the stop element 2 also prevents contaminants from entering the body 1 of the connection element structure, so as to enhance the efficiency of subsequent processes.

Preferably, after the lifting-laying tool 6 has lifted the connection element structure, a comparison device 7 compares the connection element structure with the target 10 to determine its mounting position or mounting distance; and the lifting-laying tool 6 moves the connection element structure to a default height a above the mounting position of the target according to a comparison message of the comparison device 7; the lifting-laying tool 6 releases or loosens the connection element structure, such that the connection element structure falls onto the mounting position of the target 10.

Preferably, after the lifting-laying tool 6 has lifted the connection element structure, a comparison device 7 compares the connection element structure with the target 10 to determine the position or distance of the weldable surface 102 at the mounting position; the lifting-laying tool 3 moves the connection element structure to a predetermined height a above the weldable surface 102 of the target 10 according to a comparison message of the comparison device 7; and the lifting-laying tool 6 releases or loosens the connection element structure, such that the connection element structure falls onto the weldable surface 102 of the target 10.

Preferably, the lifting-laying tool 6 is a forceps-like tool, clasp-like tool, vacuum extraction device, magnetic suction device or resilient movable component, such that the present disclosure meets the needs related to a mounting process.

Preferably, the stop element 2 is mounted on the body 1 to provide a hermetic seal thereto when the tool 6 is a vacuum extraction tool, such that the tool 6 extracts the connection element structure without failure, air leakage or difficulty.

Preferably, the comparison device 7 is a visual comparison device, distance comparison device, image comparison device, AI comparison device or photographic comparison device, such that the present disclosure meets the needs related to a mounting process.

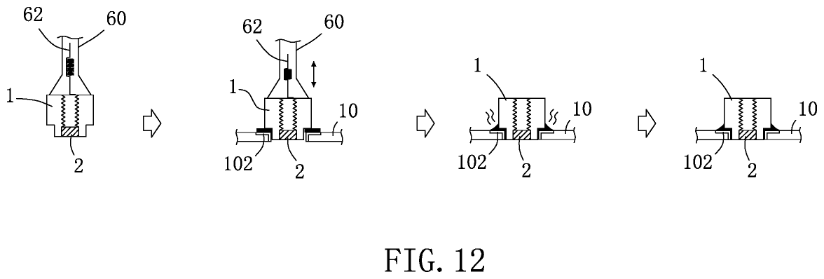

Referring to FIG. 12, the present disclosure further provides a method of mounting a connection element structure on a target, comprising the steps of: providing a lifting-laying tool 6 to lift the connection element structure; moving the connection element structure to a mounting position of the target 10 with the lifting-laying tool 6; sensing, by the lifting-laying tool 6, a feedback message indicative of contact between the connection element structure and the target 10 and then releasing or loosening the connection element structure from the lifting-laying tool 6 to lay the connection element structure at the mounting position of the target 10, thereby allowing the connection element structure to be welded to the weldable surface 102 of the target 10.

The lifting-laying tool 6 has a sensor 62 (for example, a sensor capable of resilience). When the lifting-laying tool 6 moves the connection element structure to the mounting position of the target 10, the sensor 62 of the lifting-laying tool 6 senses a feedback message indicative of contact between the connection element structure and the target 10, the lifting-laying tool 6 releases or loosens the connection element structure, such that the connection element structure is laid at the mounting position of the target 10. Therefore, the present disclosure meets the needs related to a mounting process.

In an embodiment of the present disclosure, after the connection element structure has been in contact with the target 10 to thereby enter an electrical conduction state, the sensor 62 senses a resultant feedback message. The feedback message drives the lifting-laying tool 6 to release or loosen the connection element structure.

The method of mounting a connection element structure on a target according to the present disclosure has advantageous technical features described below. The lifting-laying tool 6 lifts the connection element structure and moves the connection element structure to a mounting position of the target 10. The lifting-laying tool 6 presses the connection element structure downward against the target 10 and then releases or loosens the connection element structure, such that the connection element structure is laid at the mounting position of the target 10. Therefore, the present disclosure meets the needs related to a mounting process.

Furthermore, the method of mounting a connection element structure on a target according to the present disclosure has advantageous technical features described below. The lifting-laying tool 60 lifts the connection element structure moves the connection element structure to the mounting position of the target 10. The lifting-laying tool 6 presses resiliently the connection element structure against the target 10 and then releases or loosens the connection element structure to allow the connection element structure to be laid at the mounting position of the target 10. Therefore, the present disclosure meets the needs related to a mounting process.

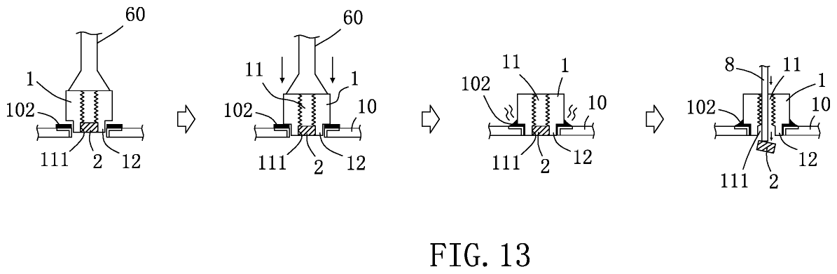

Referring to FIG. 13, in an embodiment of the present disclosure, when the body 1 is mounted on and coupled to the target 10, the stop element 2 prevents the heated-and-molten solder on the weldable surface 102 from entering or flowing into the connection opening 111. After the solder has been introduced and cooled to enable the body 1 to be fixed to the target 10, the stop element 2 is removed from the connection opening 111 with the tool 8, so as to restore the fitting function of the connection portion 11.

In an embodiment of the present disclosure, a welding layer (i.e., the weldable surface 102) is disposed between the target 10 and a lateral part of the fixation portion 12 of the body 1 or between the target 10 and the fixation portion 12 of the body 1. Thus, the body 1 is firmly mounted on the target 10.

In an embodiment of the present disclosure, the body 1 and the target 10 each have a weldable surface 102, and the weldable surface 102 is made of tin or copper or nickel.

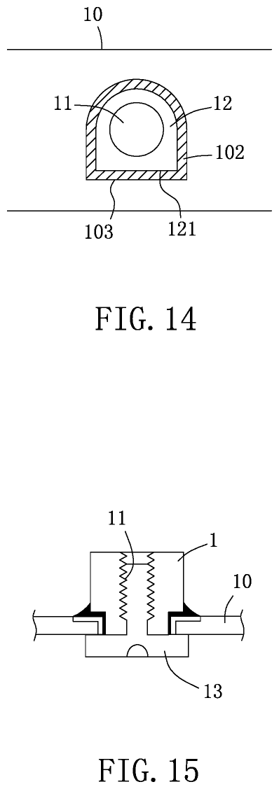

Referring to FIG. 14, the fixation portion 12 of the body 1 has a rotation-proof portion 121, and the target 10 has a corresponding rotation-proof portion 103. The rotation-proof portion 121 and the corresponding rotation-proof portion 103 prevent each other from rotating. A welding layer (i.e., the cooled weldable surface 102) is disposed between the rotation-proof portion 121 and the corresponding rotation-proof portion 103 to increase the strength of the bonding between the body 1 and the target 10, such that the body 1 and the target 10 are firmly fitted together.

Referring to FIG. 15, the connection portion 11 is fitted to a corresponding fastening element 13. The corresponding fastening element 13 is coupled to the connection portion 11, so as to increase the strength of the bonding between the body 1 and the target 10, thereby allowing the body 1 and the target 10 to be firmly fitted together.

In conclusion, the present disclosure is aimed at providing a method of mounting a connection element structure on a target, so as to enhance the efficiency of subsequent processes.

While the present disclosure has been described by means of specific embodiments, numerous modifications and variations could be made thereto by those skilled in the art without departing from the scope and spirit of the present disclosure set forth in the claims.

What is claimed is:

1. A method of mounting a connection element structure on a target, the connection element structure comprising a body and a stop element, the method comprising the steps of:
providing a lifting-laying tool to lift the connection element structure;
moving the connection element structure to a default height above a mounting position of the target with the lifting-laying tool; and
releasing or loosening the connection element structure from the lifting-laying tool to lay the connection element structure at the mounting position of the target.

2. A method of mounting a connection element structure on a target, the connection element structure comprising a body and a stop element, the method comprising the steps of:
providing a lifting-laying tool to lift the connection element structure;
moving the connection element structure to a mounting position of the target with the lifting-laying tool; and
pressing the connection element structure downward against the target with the lifting-laying tool and releasing or loosening the connection element structure from the lifting-laying tool to lay the connection element structure at the mounting position of the target.

3. The method of mounting a connection element structure on a target according to claim 2, wherein pressing resiliently the connection element structure against the target with the lifting-laying tool.

4. A method of mounting a connection element structure on a target, the connection element structure comprising a body and a stop element, the method comprising the steps of:
providing a lifting-laying tool to lift the connection element structure;
moving the connection element structure to a mounting position of the target with the lifting-laying tool; and
sensing, by the lifting-laying tool, a feedback message indicative of contact between the connection element structure and the target and releasing or loosening the connection element structure from the lifting-laying tool to lay the connection element structure at the mounting position of the target.

5. The method of mounting a connection element structure on a target according to claim 1, further comprising the steps of: comparing, by a comparison device, the connection element structure with the target to determine its mounting position or mounting distance after the lifting-laying tool has lifted the connection element structure; and moving the connection element structure to the mounting position of the target with the lifting-laying tool according to a comparison message of the comparison device.

6. The method of mounting a connection element structure on a target according to claim 2, further comprising the steps of: comparing, by a comparison device, the connection element structure with the target to determine its mounting position or mounting distance after the lifting-laying tool has lifted the connection element structure; and moving the connection element structure to the mounting position of the target with the lifting-laying tool according to a comparison message of the comparison device.

7. The method of mounting a connection element structure on a target according to claim 4, further comprising the steps of: comparing, by a comparison device, the connection element structure with the target to determine its mounting position or mounting distance after the lifting-laying tool has lifted the connection element structure; and moving the connection element structure to the mounting position of the target with the lifting-laying tool according to a comparison message of the comparison device.

8. The method of mounting a connection element structure on a target according to claim 1, wherein the body of the connection element structure has a connection portion and a fixation portion, the connection portion being disposed in the body, the body having at least one connection opening, the fixation portion being fixed to an object, wherein the stop element of the connection element structure is disposed at the connection opening.

9. The method of mounting a connection element structure on a target according to claim 2, wherein the body of the connection element structure has a connection portion and a fixation portion, the connection portion being disposed in the body, the body having at least one connection opening, the fixation portion being fixed to an object, wherein the stop element of the connection element structure is disposed at the connection opening.

10. The method of mounting a connection element structure on a target according to claim 4, wherein the body of the connection element structure has a connection portion and a fixation portion, the connection portion being disposed in the body, the body having at least one connection opening, the fixation portion being fixed to an object, wherein the stop element of the connection element structure is disposed at the connection opening.

11. The method of mounting a connection element structure on a target according to claim 1, wherein the stop element prevents molten solder from entering or flowing into the connection opening.

12. The method of mounting a connection element structure on a target according to claim 2, wherein the stop element prevents molten solder from entering or flowing into the connection opening.

13. The method of mounting a connection element structure on a target according to claim 4, wherein the stop element prevents molten solder from entering or flowing into the connection opening.

14. The method of mounting a connection element structure on a target according to claim 11, wherein, upon its introduction, the solder is cooled to join the body and the target together, and then a tool is configured to remove the stop element from the connection opening.

15. The method of mounting a connection element structure on a target according to claim 12, wherein, upon its introduction, the solder is cooled to join the body and the target together, and then a tool is configured to remove the stop element from the connection opening.

16. The method of mounting a connection element structure on a target according to claim 13, wherein, upon its introduction, the solder is cooled to join the body and the target together, and then a tool is configured to remove the stop element from the connection opening.

17. The method of mounting a connection element structure on a target according to claim 1, wherein the body has a connection portion, the connection portion is fitted to a fastening element for fitting the body and the target together.

18. The method of mounting a connection element structure on a target according to claim 2, wherein the body has a connection portion, the connection portion is fitted to a fastening element for fitting the body and the target together.

19. The method of mounting a connection element structure on a target according to claim 4, wherein the body has a connection portion, the connection portion is fitted to a fastening element for fitting the body and the target together.

20. The method of mounting a connection element structure on a target according to claim 1, wherein the body has a rotation-proof portion, and the target has a corresponding rotation-proof portion, wherein the rotation-proof portion and the corresponding rotation-proof portion prevent each other from rotating.

21. The method of mounting a connection element structure on a target according to claim 2, wherein the body has a rotation-proof portion, and the target has a corresponding rotation-proof portion, wherein the rotation-proof portion and the corresponding rotation-proof portion prevent each other from rotating.

22. The method of mounting a connection element structure on a target according to claim 4, wherein the body has a rotation-proof portion, and the target has a corresponding rotation-proof portion, wherein the rotation-proof portion and the corresponding rotation-proof portion prevent each other from rotating.

23. The method of mounting a connection element structure on a target according to claim 20, wherein a welding layer is disposed between the rotation-proof portion and the corresponding rotation-proof portion, the welding layer is heated then cooled to solidify.

24. The method of mounting a connection element structure on a target according to claim 21, wherein a welding layer is disposed between the rotation-proof portion and the corresponding rotation-proof portion, the welding layer is heated then cooled to solidify.

25. The method of mounting a connection element structure on a target according to claim 22, wherein a welding layer is disposed between the rotation-proof portion and the corresponding rotation-proof portion, the welding layer is heated then cooled to solidify.

26. The method of mounting a connection element structure on a target according to claim 1, further comprising a fixing element disposed at the fixation portion or the object to fix the fixation portion to the object.

27. The method of mounting a connection element structure on a target according to claim 2, further comprising a fixing element disposed at the fixation portion or the object to fix the fixation portion to the object.

28. The method of mounting a connection element structure on a target according to claim 4, further comprising a fixing element disposed at the fixation portion or the object to fix the fixation portion to the object.

29. The method of mounting a connection element structure on a target according to claim 1, wherein a welding layer is disposed between the target and a lateral part of the fixation portion of the body or between the target and the fixation portion of the body, the welding layer is heated then cooled to solidify.

30. The method of mounting a connection element structure on a target according to claim 2, wherein a welding layer is disposed between the target and a lateral part of the fixation portion of the body or between the target and the fixation portion of the body, the welding layer is heated then cooled to solidify.

31. The method of mounting a connection element structure on a target according to claim 4, wherein a welding layer is disposed between the target and a lateral part of the fixation portion of the body or between the target and the fixation portion of the body, the welding layer is heated then cooled to solidify.
